(19) United States
(12) Patent Application Publication
(10) Pub. No.: US 2002/0181914 A1
(43) Pub. Date: Dec. 5, 2002

(54) Method and apparatus for decreasing signal propagation delay in a waveguide

(76) Inventor: David B. Jansen, Louisville, CO (US)

Correspondence Address: DORSEY & WHITNEY, LLP, INTELLECTUAL PROPERTY DEPARTMENT, 370 SEVENTEENTH STREET, SUITE 4700, DENVER, CO, 80202-5647, US

(21) Appl. No.: 10/134,273

(22) Filed: Apr. 25, 2002

Related U.S. Application Data
(60) Provisional application No. 60/287,196, filed on Apr. 27, 2001.

(51) Int. Cl. G02B 6/10; G02B 6/26; G02B 6/34

(52) U.S. Cl. 385/130; 385/142; 385/30; 385/36; 385/37; 359/342

(57) ABSTRACT

A waveguide for decreasing signal propagation delay including an evanescent region and an amplification region. In various embodiments, the evanescent region includes varying index of refraction regions, such as one or more thin film regions and one or more fiber Bragg grating regions, one or more frustrated internal reflection constructs, or one or more undersized waveguides. In various embodiments, the amplification region includes doped amplifiers and other amplifier types that use propagated pump photons to provide amplification, or semiconductor amplifiers or other amplifier types that use electrical power to provide amplification. A method for decreasing signal propagation delay includes propagating a signal having a signal frequency into an evanescent region. After propagation through the evanescent region, amplifying the attenuated signal.

### CROSS-REFERENCE TO RELATED APPLICATIONS

This application is related to and claims the benefit of provisional patent application No. 60/287,196 entitled “Method and Apparatus for Decreasing Optical Fiber Propagation Delay” filed on Apr. 27, 2001, which is hereby incorporated by reference in its entirety.

### FIELD OF THE INVENTION

The present invention relates generally to waveguides, and more specifically to a method and apparatus for decreasing signal propagation delay in a waveguide.

### BACKGROUND OF THE INVENTION

The potential that lies in broadband communications is nearly limitless; as are the user services it will produce. For example, broadband communications potentially can provide the ability to download films over the Internet with image quality comparable to HDTV, order music or TV programs instantaneously, and establish fast data links between a hotel room and a home. However, the ever-increasing demand for bandwidth is taxing the traditional telecom infrastructure and existing data networks, such as the Internet, and creating demand for unique approaches to building next-generation data networks.

Optical communications technology advances are progressing at a phenomenal rate. Every day technology news headlines herald the latest breakthroughs emerging from the university research center laboratories and R&D departments of commercial equipment manufacturers. However, the data capacity of a conventional fiber optical cable, i.e., the maximal rate at which information may be transmitted through the cable without error, is finite and current technology is approaching the theoretical limits of conventional optical fibers due to the nonlinearities in the fiber optical cable.

Further, as advances in computing technology allow processing to occur at faster and faster rates, the time required for processors to exchange data increasingly limits the effective processing power. For example, consider two computers, A and B, in a distributed processing configuration where they share information and work together to perform the task they have been programmed to complete. If A and B are conventional PC type computers, each with an Intel™ Pentium™ III processor and a 100 MHz data bus, it takes roughly 20 nsec for the processor to retrieve the data it needs to perform calculations and operations from local memory. If A needs information from B and they are 100 km apart connected by conventional fiber optic cable, then the amount of time it takes for A to get the data from B due to propagation delay, is roughly 460 usec, which is about 23,000 times longer than from local memory. In other words, if A and B were human and having a conversation, the propagation delay is equivalent to A asking B a question and having to wait over five hours for a response—not a very efficient or lively conversation to say the least.

### SUMMARY OF THE INVENTION

Embodiments of the present invention effectively speed up the conversation between A and B. One embodiment of the present invention provides a waveguide comprising one or more regions of evanescent wave propagation followed by one or more cooperating amplification regions. Generally speaking, a waveguide according to the invention provides signal propagation delays that are less than typical signal propagation delays of conventional waveguides. In one example, the at least one evanescent region defines a photonic bandgap at the signal frequency.

The evanescent region (s) include, in one example, at least one first region having a first index of refraction and at least one second region having a second index of refraction that is different than the first index of refraction. The first and second regions include one or more thin film layers, such as dielectric thin film layers, having varying indices of refraction. The thin film layers may be arranged substantially transverse to the propagation path of the signal, arranged substantially parallel to the path, or arranged in other configurations. The thin film layers may be arranged directly adjacent the gain region or with space therebetween, and may together be repeated along the length of the waveguide.

In alternative embodiments of the invention, the evanescent region includes at least one frustrated total internal reflection (FTIR) construct. The FTIR defines a first prism region and a second prism region, in one example, with a boundry region therebetween. In another alternative embodiment of the invention, the evanescent region includes at least one photonic crystal fiber. In another alternative embodiment of the invention, the evanescent region includes at least one undersized waveguide. The undersized waveguide has frequency cutoff higher than the signal frequency.

The at least one gain region includes means for amplifying the signal. Such means for amplifying the signal include an optical amplifier operably coupled with the evanescent region. The gain or amplification region may be integrated in the at least one evanescent region.

In another alternative of the present invention, the waveguide includes a core defining a first index of refraction, and a cladding surrounding the core, the cladding defining a second index of refraction less than the first index of refraction such that the electromagnetic signal is propagated within the core. The core further defines at least one region having a periodic variation of the index of refraction. The varying index of refraction region includes, in one example, at least one fiber grating having a periodic variation of the index of refraction. In one embodiment, the at least one fiber grating defines a first fiber grating section and a second fiber grating section, with the first fiber grating section and the second fiber grating section being separated by a portion of the core, and the core further defining an amplification region adjacent the second fiber grating section.

For most embodiments, the evanescent region is configured to increase the velocity of the electromagnetic signal as the electromagnetic signal propagates therethrough. In addition, the gain region is configured to amplify the electromagnetic signal following increase in velocity of the electromagnetic signal.

Another alternative of the present invention is an optical waveguide for propagating a signal having a signal wavelength and for propagating a pump signal having a pump wavelength. The waveguide comprises: at least one first region having a first index of refraction; at least one second region coupled with the first region, the second region having a second index of refraction; the first index of refraction being different than the first index of refraction such that the first index of refraction and the second index of refraction define a photonic bandgap at the signal wavelength; the first index of refraction and the second index of refraction configured to transmit the pump signal without substantial attenuation; and at least one amplifier operably coupled with the at least one first region and the at least one second region.

Another alternative of the present invention is an optical waveguide for propagating a signal having a signal frequency. The waveguide comprises: at least one first region having a first index of refraction; at least one second region coupled with the first region, the second region having a second index of refraction; the first index of refraction being different than the first index of refraction such that the first index of refraction and the second index of refraction define a photonic bandgap at the signal frequency; and at least one amplifier operably coupled with the at least one first region and the at least one second region.

Another alternative of the present invention is an optical waveguide for propagating a signal having a signal wavelength and for propagating a pump wavelength signal having a pump wavelength comprising: an undersized waveguide with a wavelength cutoff higher than the signal wavelength, and with a cutoff wavelength lower than the pump wavelength; and an amplification region operably coupled with the undersized waveguide, the amplification region configured to amplify the signal.

A signal guiding apparatus conforming to the present invention includes a signal source and a pump laser source. The signal guiding apparatus further includes a waveguide defining an input and an output, the waveguide further including at least one evanescent region operably coupled with at least one gain region, the evanescent region configured to increase the velocity of the signal, and the amplification region configured to amplify the signal. A coupler is operably connected with the signal laser source and with the pump laser source, and the coupler is further operably coupled with the input of the waveguide. A decoupler is operably connected with the output of the waveguide.

A method conforming to the present invention includes providing at least one evanescent region configured to attenuate the signal frequency of the signal. The method further includes providing at least one amplification region configured to amplify the attenuated signal. The signal is propagated through the evanescent region, and then propagated through the amplification region. Hence, the evanescent region is configured in a sense to attenuate the signal, and to increase the velocity of the signal. The attenuated signal after propagation through the evanescent region is amplified in the amplification region. In an embodiment using pump photon to provide amplification, the method further includes propagating a pump signal through the evanescent region, and propagating a pump signal through the amplification region to amplify the attenuate signal. In an embodiment using electrical power to provide amplification, the method includes supplying electrical power to the amplification region.

Apparatus and methods conforming to the present invention increase the propagation speed of optical fibers over long distances, and can be readily employed in a practical and commercially deployable communications systems. The summarized aspects of the present invention and various combinations, alternations, substitutions, and the like, are described in more detail below in the Detailed Description section.

### BRIEF DESCRIPTION OF THE FIGURES

The detailed description will refer to the following drawings, wherein like numerals refer to like elements, and wherein:

FIG. 1 is a schematic block diagram illustrating a waveguide structure according to one embodiment of the invention;

FIG. 2A is a diagram illustrating a waveguide having alternating evanescent regions and gain regions arranged with space therebetween, according to one embodiment of the present invention;

FIG. 2B is a diagram illustrating a waveguide having alternating evanescent regions and gain regions arranged back-to-back, according to one embodiment of the present invention;

FIG. 3 is a diagram illustrating a waveguide having a thin film evanescent region and a gain region, according to one embodiment of the present invention;

FIG. 4 is a graph illustrating the transmission of the thin film region as a function of the wavelength and highlighting the respective pump and signal wavelength for the thin film embodiment illustrated in FIG. 3;

FIG. 5 is a graph illustrating the propagation delay as a function of the gain region length for a communication signal transmitted with the waveguide illustrated in FIG. 3 compared with the propagation delay of a data signal in a conventional fiber optical cable;

FIG. 6 is a diagram illustrating a waveguide structure that includes a mirror or other reflecting structure defining an outside cylindrical surface and includes one or more thin film layers and a gain region within the reflecting surface, according to one embodiment of the present invention;

FIG. 7 is a section view taken along line 7-7 of FIG. 6;

FIG. 8 is an alternative section view taken along line 7-7 of FIG. 6;

FIG. 9 is a diagram illustrating a waveguide that includes a mirror or other reflecting structure defining an outside cylindrical surface and includes one or more thin film layers and a gain region within the reflecting surface, according to one embodiment of the present invention;

FIG. 10A is a diagram illustrating a waveguide comprising an evanescent region including a fiber Bragg grating, and a gain region, according to one embodiment of the present invention;

FIG. 10B is a diagram illustrating a waveguide comprising an evanescent region including a first fiber grating and a second fiber grating with a fiber core defining a space therebetween, the first and second fiber grating followed by a gain region, according to one embodiment of the present invention;

FIG. 11A is a diagram illustrating a waveguide comprising an evanescent region including a frustrated total internal reflection construct, and a gain region, according to one embodiment of the present invention;

FIG. 11B is a diagram illustrating a waveguide comprising an evanescent region including an alternative frustrated total internal reflection construct, and a plurality of gain regions, according to one embodiment of the invention;

FIG. 12 is a block diagram illustrating a waveguide comprising an evanescent region employing a photonic crystal fiber, and a gain region, according to one embodiment of the present invention;

FIG. 13A is a diagram illustrating a waveguide comprising an evanescent region including an undersized waveguide, and a gain region, according to one embodiment of the present invention;

FIG. 13B is a diagram illustrating a waveguide comprising a plurality of evanescent regions employing undersized waveguides with each evanescent region followed by a gain region;

FIG. 13C is a diagram illustrating a waveguide comprising a plurality of evanescent regions employing undersized waveguides with each evanescent region followed by a gain region;

FIG. 13D is a diagram illustrating a waveguide comprising a plurality of evanescent regions employing undersized waveguides with integrated gain regions;

FIG. 14 is a block diagram of a signal transmission system employing a waveguide, according to one embodiment of the invention;

FIG. 15 is a flow chart illustrating a method for propagating a signal in a waveguide, according to one embodiment of the invention; and

FIG. 16 is a block diagram of an alternative signal transmission employing a waveguide, according to one embodiment of the present invention.

### DETAILED DESCRIPTION

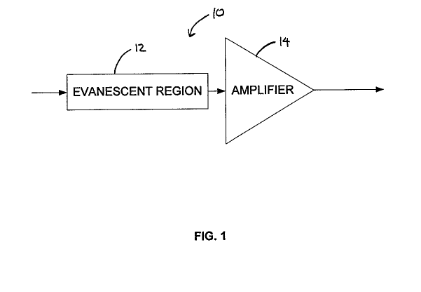

FIG. 1 is a block diagram of a waveguide 10 structure according to one embodiment of the invention. The waveguide is used, in one example, as an optical transmission medium to transmit a signal in the form of a pattern of light pulses from one point to another point. For example, the waveguide 10 could be used to transmit a data packet between two routers in a data network. The waveguide provides a transmission medium where signal propagation delays are less than signal propagation delays of conventional waveguides. For example, an optical signal transmitted through an optical waveguide according to the present invention achieves propagation delays of the signal that are less than the same signal transmitted through conventional fiber optic cables.

Numerous alternative embodiments of the invention are discussed below. It will be recognized by those skilled in the art that the various embodiments of the invention are applicable to reducing propagation delays for signals being propagated as electromagnetic waves such as electric waves, radio waves, light waves in the visible and nonvisible spectrums, x-ray signals, microwave signals, and the like. It will also be recognized by those skilled in the art that embodiments of the invention may be employed to guide a signal along a physically short path, such as between two processors on a PC board or in a splicing arrangement between conventional waveguides (e.g., between conventional optical fibers), as well being employed to guide a signal along a physically longer path, such as in a cable that guides optical signals between two routers in a network. Accordingly, the use of the term “waveguide” herein is meant to be interpreted broadly, and to include any structure conforming to the invention that guides a signal along a path.

Referring again to FIG. 1, the waveguide includes an evanescent region 12 and a gain region 14. In embodiments of the invention, the evanescent region 12 in a sense effectively accelerates the signal or in another sense effectively increases the velocity of the signal. Acceleration of the signal in the evanescent region, however, is oftentimes accompanied by attenuation of the signal strength. Thus, in one embodiment of the invention, the evanescent region is followed by a gain region 14 to restore the attenuated signal for further propagation in the waveguide, or to restore the attenuated signal for processing or further propagation by a connected processor, conventional waveguide, or the like.

Wave propagation in evanescent regions 12 is analogous to quantum tunneling of particles through a barrier and has been thoroughly investigated in theoretical modeling and experiments in recent years. Quantum tunneling is a direct result of Schrödinger's equation and is one of the remarkable aspects of quantum mechanics, such as is described in J. R. Oppenheimer, Phys. Rev. 31, 66 (1928), which is hereby incorporated by reference in its entirety. Simply put, quantum tunneling allows transmission of a particle across a potential barrier whose height is greater than the energy of the particle. In accordance with the present invention, evanescent regions for electromagnetic waves can be constructed by a number of different methods including: using multi-layer structures that vary the refractive index of the transmission medium, such as thin film regions or fiber gratings; using Frustrated Total Internal Reflection (FTIR); using Photonic Crystal Fibers (PCF); or using undersized waveguides.

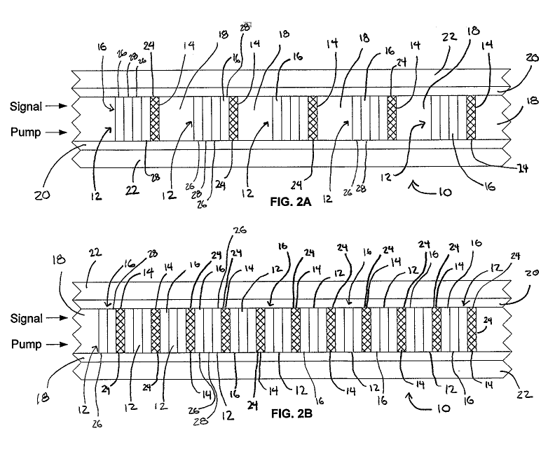

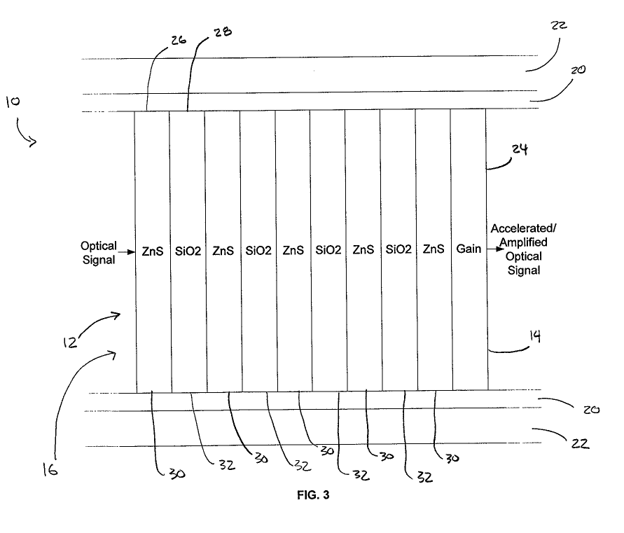

In one example of the invention, the evanescent region includes a periodically varying refractive index configuration. Such a varying refractive index configuration is implemented as thin film region, fiber Bragg grating, and the like, in examples of the invention. At certain forbidden energies, the varying refractive index configuration defines a photonic bandgap such that the forbidden energies will not be allowed to transmit through it. At these frequencies the wavevector takes on an imaginary value. In some configuration of the invention for transmitting optical signals, such as is illustrated in FIGS. 2A, 2B, and 3, the periodic structure includes a thin film region 16 having alternating layers of high and low index of refraction dielectric regions. The interface between regions with a different dielectric constant and absorption index for light waves is analogous to the interface between regions with different potential energy V for electron waves. Thus, reflection of a light wave from an interface with a material with a high complex index of refraction is analogous to the reflection of an electron wave approaching a potential step of height Vo if the electron energy E<Vo.

Not all of the optical signal is reflected at the thin film region 16. Partial transmission of the optical signal through the thin film with a high index material is analogous to the tunneling of electron waves through a potential barrier of height Vo when the electron energy E<Vo, forming an evanescent region for the transmissive wave. In the evanescent region, the velocity of the signal is oftentimes increased.

A Gaussian optical wave packet, ψ(χ), with a pulse width, a, and wavenumber, ko, is given by:

$$ψ ( x ) = {( \frac{1}{{πσ}^{2}} )}^{1 / 4} {ⅇ}^{- {( x - {x}_{o} )}^{2} / 2 {σ}^{2}} {ⅇ}^{ⅈ {k}_{0} ( x - x o )} \qquad ( 1 )$$

The mean energy, <E> of the pulse is then:

<E>=kₒ²/2+1/4σ² (2)

With the above information, a waveguide 10 according to one embodiment of the present invention defines a photonic bandgap optimizing the relationship between Vo and E. In conventional communication systems, a photonic bandgap defines a region over which a range of frequencies of light are reflected or wave propagation is forbidden. Such conventional employment of photonic bandgaps can be found in waveguide bends, waveguide intersections, filters that eliminate a spectrum of light, and elsewhere.

In implementations of the invention, one or more evanescent regions 12 including the multi-layer structure region, FTIR region, PCF region, undersized waveguide region, or the like define a photonic bandgap. The photonic bandgap, however, is not optimized for reflection of the incident light such as in conventional uses. Rather, in embodiments of the present invention, the photonic bandgap is configured for evanescent wave propagation of the signal through the photonic bandgap.

In the example of a waveguide 10 including a thin film region 16, the photonic bandgap is defined by alternating high and low index of refraction materials. The complex index of refraction nⱼ for a given layer, j, is:

nⱼ=Nⱼ+iKⱼ (3)

where N is the normal index refraction and K is the absorption coefficient. The effective optical thickness, gⱼ, for the jth layer is then:

gⱼ=kₒnⱼtⱼ cos φⱼ (4)

where tⱼ is the physical thickness of the layer, φⱼ is angle of incidence, and kₒ is the wavenumber. If E is defined as the electric field and it is related to the magnetic field, H, by Hⱼ=uⱼEⱼ, the following equations are applied iteratively at each surface:

$${E}_{j + 1} = {E}_{j} cos {g}_{j} + \frac{i {H}_{j}}{{u}_{j}} sin {g}_{j} \qquad ( 5 )$$

Hⱼ₊₁=i·uⱼEⱼ sin gⱼ+Hⱼ cos gⱼ (6)

Equations (5) and (6) may then be described in matrix form:

$$( \begin{matrix}{E}_{j + 1} \\ {H}_{j + 1}\end{matrix} ) = ( \begin{matrix}cos {g}_{j} & i / {u}_{j} sin {g}_{j} \\ i \cdot {u}_{j} sin {g}_{j} & cos {g}_{j}\end{matrix} ) ( \begin{matrix}{E}_{j} \\ {H}_{j}\end{matrix} ) \qquad ( 7 )$$

From Equation 7, the E-field magnitude and phase of the incident light through the entire thin film structure 16 can be calculated. Equations 3-7 can be used to design waveguides 10 having evanescent thin film regions 16 according to the present invention optimized for various characteristics, such as for the angle, wavelength, transmission, and phase desired.

Computation of the tunneling time of the signal through the photonic bandgap structure, e.g., the thin film region 16, using the E-field transmission phase is discussed in Th. Martin and R. Landauer, Physical Review A, Vol. 45, No. 4, “Time delay of evanescent electromagnetic waves and the analogy to particle tunneling,” which is hereby incorporated by reference in its entirety. It should be noted that the exact method for calculating tunneling times is still being debated in the scientific community and there are several approaches to the calculation. Using the approach in Martin et al., which has had good correlation with recent experimental results, the group delay transmission time of a signal in the photonic bandgap, τ_{g}, is:

$${τ}_{g} = \frac{\partial {φ}_{T}}{\partial ω} + \frac{- \partial {φ}_{T}}{\partial θ} \frac{sin θ}{c \cdot k cos θ} \qquad ( 8 )$$

where φ_{T} is the transmission phase, θ is the angle of incidence, and ω is the frequency. In some instances, a signal transmitted in a waveguide according to the present invention demonstrates superluminal light pulse propagation. Such a result, however, does not conflict with relativity because light can be viewed as an electromagnetic wave and as such does not have mass. Moreover, such a result does comport with existing theories of electromagnetism and quantum mechanics.

In addition to the evanescent region 12, a waveguide according to the invention also includes a gain or amplification region 14. The gain or amplification region 14 can be a region separate from the evanescent region, or can be combined or integrated with the evanescent region. In some embodiments, an optical amplifier is used to implement the gain region. Optical amplifiers are used extensively in conventional long-haul fiber optical data transmission systems. These amplifiers regenerate optical signals without the expense and limitations of electrical regenerators, which convert the optical signal back into an electrical signal using a photodetector and amplifier, and then using a laser diode to convert the signal back into the optical domain. Nonetheless, in an embodiment conforming to the present invention, an electrical regenerator could be used in place of the optical amplifier.

Optical amplifiers employable in the gain region 14 using a single-mode optical fiber having a core doped with a rare earth element such as Erbium, Neodymium, or Ytterbium are known. An optical amplifier using such a doped fiber is typically referred to as an optical fiber amplifier. Optical fiber amplifiers exhibit low noise and low coupling loss to an optical transmission line. In operation, signal light to be amplified is input into the doped fiber to propagate therein, while pump light is introduced into the doped fiber in the same direction as the propagation direction of the signal light or in the opposite direction. In the doped region, the pump light is converted into signal light, and the signal light is amplified along the doped region. The amplified signal light exits from an output port.

One type of optical fiber amplifier that may be employed in the gain region 14 in embodiments of the present invention is an erbium doped fiber amplifier (EDFA). Examples of EDFA amplifiers include the JDS Uniphase™ OAC-22F-41, the Corning™ 1906OFA, and the BaySpec IntelliGain™ Metro-III_AE. Amplification in an EDFA optical amplifier is achieved by optically exciting the erbium by injecting photons (pump photons) with wavelengths corresponding to the erbium absorption peaks, which elevates the electrons to metastable states, and then causes stimulated emission of the signal photons. Other fiber dopant materials can be used as well.

Doped amplifiers are also fabricated using very short waveguide structures. Amplification in a very short waveguide structure is achieved by using very highly doped silica in an integrated optical configuration, which in addition to small size, allows for the potential of achieving a very low manufacturing cost.

Optical amplifier gain is defined as ratio of signal output power to the signal input power and can be expressed as:

$${G}_{s} ( dB ) = 10 {log}_{10} ( \frac{{P}_{s o}}{{P}_{s i}} ) \qquad ( 16 )$$

where Pₛₒ and Pₛᵢ are the output and input signal powers, respectively. The amplifiers have limitations with respect to the signal levels they work with and therefore two additional parameters, P_{si min} and P_{so sat} are defined. P_{s min} is the minimum signal input level the amplifier can effectively amplify and is a result of the amplifier not being completely noise free. P_{so sat} is the signal output power level where the gain of the amplifier is reduced by 3 dB from the linear small-signal gain. Gains of EDFA type amplifiers can approach 50 dB with output power levels up to 30 dBm. Incremental gains can be as high as 2.5 dB per mm and noise figures of less than 4 dB can be achieved.

Other techniques of optical amplification suitable for use in accordance with the present invention include Raman type amplifiers and Semiconductor Optical Amplifiers (SOAs). Gain occurs in Raman amplifiers due to the scattering of photons of one frequency (the pump) into photons of another frequency (the signal) with the emission of a quantum of vibration (a phonon). Examples of Raman amplifiers include the JDS Uniphase™ RL 30, the Corning™ 5000R, and the Nortel™ MGM.

SOAs operate similarly to laser diodes and are typically constructed out of materials that include III-V semiconductor materials, such as GaAs, InP, GaAIAs, and the like. Electrical current is injected into a small waveguide region, which excites the electrons of the semiconductor material. Amplification occurs when the stimulated electrons return to the ground level and the excess energy is released as additional identical photons and high gains can be achieved in very small regions. Examples of SOA type amplifiers include the OptoSpeed™ SOA1300CRI/P and the Kamelian™ OPA-0302.

Other optical amplifiers that may be employed in embodiments of the present invention include: an erbium doped waveguide amplifier (EDWA), such as the Teem Photonics Metro™ EDWA-DWDM-OO; silicon nanocrystals such as is described in Pavesi et al. “Optical Gain in Silicon Nanocrystals,” Nature, Vol. 408, Nov. 23, 2000, which is hereby incorporated by reference in its entirety; and polariton amplification, such as is described in Saba et al. “High-temperature ultrafast polariton parametric amplification in semiconductor microcavities,” Nature, Vol. 44, Dec. 13, 2001, which is hereby incorporated by reference in its entirety. Various types of EDFA amplifiers and other types of optical amplifiers suitable for use in accordance with the present invention are described in Bass, M. et al. editors, Handbook of Optics 2^{nd} Edition Volume IV (2001), which is hereby incorporated by reference in its entirety.

FIG. 2A is a schematic diagram of an optical waveguide 10 according to one embodiment of the invention. In one example, the optical waveguide is configured so that it may be employed in any conventional communication system that currently uses conventional fiber optic cables. For example, the optical waveguide may be spliced or connected between conventional fiber optic cabling or may be used in place of conventional fiber optic cabling. In another example, a waveguide conforming to the present invention may be coupled with an air-based type fiber, such as those provided by OmniGuide Communications™, Inc.

The optical waveguide defines a flexible cylinder having a core 18 along a longitudinal axis with a high refractive index surrounded by a low index cladding 20. Light or other electromagnetic signals propagate within the core 18 according to the principles of total internal reflection. In one example, an outer jacket 22 is employed to protect the core and low index cladding. Within the low index cladding, the optical waveguide includes one or more evanescent regions 12 and one or more gain regions 14. The evanescent region(s) and the gain region(s) are arranged so that a signal propagating through the core is incident upon the evanescent region and thereby accelerated. In addition, the evanescent region(s) and the gain region(s) are arranged so that the accelerated signal that passes through the evanescent region is incident upon the gain region and thereby amplified.

In the embodiment of the invention illustrated in FIG. 2A, the evanescent region 12 includes a thin film region 16 and the gain region 14 includes an optical amplifier 24. The thin film layers have different indices of refraction and can be deposited into a substrate or otherwise integrated into a fiber core by known techniques. As discussed herein, other embodiments of the invention comprise an evanescent region including varying index of refraction regions integrated in the core, such as in the case of doped region, FBG, and the like. The evanescent regions and the gain regions may be configured to alternate along the length, i.e., the longitudinal axis, of the waveguide.

The embodiment illustrated in FIG. 2A includes a plurality of thin film regions 16 and gain regions 14. Each thin film region is followed by a gain region. The combination of a thin film region and a gain region is repeated along the waveguided with fiber core 18 defining a space therebetween.

FIG. 2B illustrates a waveguide to conforming to the present invention that includes alternating evanescent 12 thin film regions 16 and gain regions 14 with the combination of a thin film region and a gain region configured back-to-back. In such a back-to-back arrangement, when the signal exits the gain region it immediately enters a following evanescent region. In contrast, referring to the FIG. 2A embodiment, when a signal exits the gain region it enters a portion of the fiber core and is propagated for some distance before encountering a subsequent evanescent region. Other embodiments of the invention may only include a single thin film region and a single gain region.

The evanescent wave propagation region 12 includes a thin film region 16 having dielectric thin films arranged so that the index of refraction of the thin films alternate between a thin film layer 26 with a high index of refraction and a thin film layer 28 with a low index of refraction. The amplification or gain region 14 includes one or more optical amplification configurations. Alternative arrangements for the thin film region and the gain region are discussed in more detail below.

Referring still to FIG. 2A, in this embodiment, an EDFA optical amplifier 24 is employed in the gain regions. Accordingly, pump photons are introduced into the waveguide 10 to provide amplification of the signal in the gain region. The thin film region 16 and the gain region 14 are alternately repeated along the length of the waveguide, with the optical communication signal and the optical amplification signal entering the structure from the left, in one example.

Thin film regions 16 with alternating layers (26, 28) of different index of refraction mediums are used extensively in conventional optical systems and components. Thin films perform many different functions and are fabricated and deployed in a wide variety of systems and topologies. Generally, thin films are conventionally used to control the reflection and transmission characteristics of light, such as to filter out a spectrum of light. Some thin film examples employable in a waveguide according to the invention include: antireflection coatings for transmissive optical components such as Linos Photonics™, Part # ARB 1, reflective coatings to increase the reflectivity of a mirror such as TwinStar Optics™, Part #M1000, and filters which tailor the spectra of the light through an optical component by allowing certain wavelengths to be transmitted or reflected, such as Thin Films Research™, Part #DF-501. These structures can also be used to control the polarization properties of an optical component, such as Linos Photonics™, Part #TWSP as well.

A general class of alternating high and low index materials employable in embodiments of the invention are referred to as dielectric thin films, metallic thin films, or optical coatings. The thin films 16 are applied to a substrate material and oftentimes include many layers of different materials. In some examples, 100 or more thin film layers are employed in a thin film structure. Numerous coating materials are available and some examples applicable to a waveguide 10 according to the invention include: Aluminum, Germanium, Gold, Magnesium Fluoride, Nickel, Silicon Dioxide (SiO₂), Tantalum Oxide, Titanium Oxide and Zinc Sulfide (ZnS) as well as many others.

These thin film coatings are typically manufactured by a deposition process where the substrate material to be coated is placed in a vacuum chamber and the coating materials are vaporized and deposited to the substrate. Some additional examples of thin films 16 generally applicable in embodiments of the invention include antireflection coatings on prescription glasses, laser line filters, such as Mellis Griot™, Part #03 FIL 206, which transmit (block) only the laser wavelength and block (transmit) all other wavelengths, and metallic thin film polarizers, such as Mellis Griot™, Part #03 FPI 029, which transmit only one polarization direction.

FIG. 3 illustrates a waveguide 10 according to the present invention having alternating evanescent regions 12 and gain regions 14. More specifically, the waveguide includes alternating thin film regions 16 and gain regions 14. The thin film region includes five ZnS high index layers 30 alternating with four SiO₂ low index layers 32. Following the thin film region 16 is the gain region 14, which includes an EDFA-type optical amplifier 24. Accordingly, pump photons are introduced into the waveguide to amplify the signal in the gain region(s). In one example, thin film regions operably coupled with gain regions are repeated along the length of the waveguide. The combination of the thin film region and gain region may be arranged with space between the subsequent combination of thin film region and gain region, or may be arranged back-to-back.

The thin film region 16, in one example, is a photonic bandgap at the communication signal frequency. Thus, the thin film region is highly reflective, and transmission of the data signal through the thin film region is achieved by evanescent wave propagation, which is analogous to quantum tunneling. In addition, the thin film regions, in one example, are substantially transmissive of the amplification signal at the pump frequency so that the pump photons will not be attenuated.

For a communication signal wavelength of 1.55 μm, which is in the C-band for fiber communication systems, and a typical amplification pump signal wavelength of 980 nm, which is the pump wavelength for EDFA amplifiers, the waveguide 10 illustrated in FIG. 3 includes a thin film region 16 having ZnS (n=2.3) 30 for the high index layer and SiO₂ 32 (n=1.5) for the low index layer. The thin film region is in a (HL)ⁿH configuration with each layer thickness being a quarter wavelength of optical thickness for the communication signal frequency. Thus, the high and low index layer thicknesses are 0.17 μm and 0.27 μm, respectively, and the total thickness of the thin film region is 1.9 μm.

Waveguides 10 coming within the scope of the present invention can include different combinations of layer thickness, number of layers, and materials for the layers to tailor the thin film region 16 configuration. For example, using more layers of the same quarter wave structure will decrease the signal transmission and increase the pump transmission, and in some instances will cause greater signal velocity increases. More complicated configurations are also envisioned so that both the data signal wavelength and the pump signal wavelength transmissions can be tailored independently.

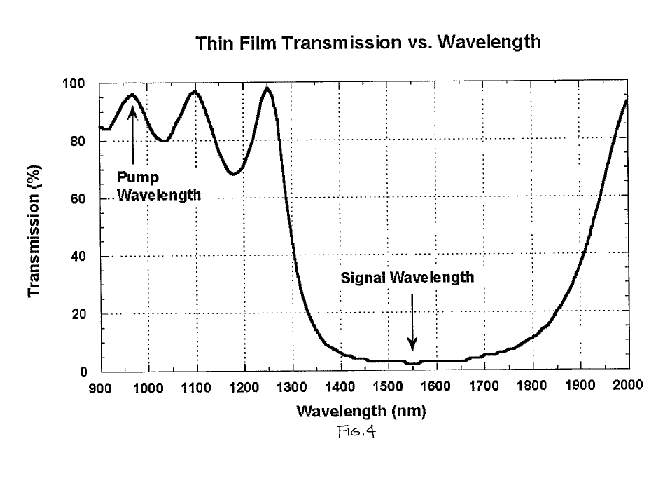

FIG. 4 is a graph illustrating the data signal transmission and the pump signal transmission percentage compared to the wavelength of the respective signal for the nine-layer thin film embodiment of the invention illustrated in FIG. 3. FIG. 4 shows that the communication signal and amplification signal wavelength transmissions are about 3% and 95%, respectively. Equation 8 is used to calculate the transmission time across the film by differentiating the calculated transmission phase with respect to frequency for the normal incidence case.

After the communication signal photons transmit through the thin film region 16, they enter the gain region 14 where they are then amplified, thereby increasing the light intensity so that long propagation distances can be achieved. As shown in FIG. 4, the amplification pump photons pass through the thin film region 16 without significant attenuation (i.e., about 5% attenuation) and enter the gain region 14 where they are used as pump energy for the communication signal photons. In some embodiments, the optical amplifier 24 is configured so that the communication signal gain is approximately equal to the inverse of the communication signal attenuation in the thin film region 16. Hence, for the embodiment illustrated in FIG. 3, the signal that was attenuated to about 3% of its preacceleration strength, i.e., infinite level, is returned to about 100%.

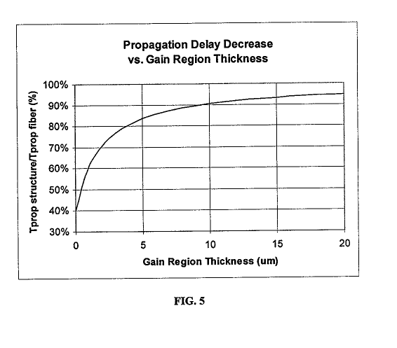

FIG. 5 is a graph illustrating the propagation delay as a function of the gain region 14 length for a communication signal transmitted with the waveguide 10 illustrated in FIG. 3 compared with the propagation delay of a data signal in a conventional fiber optical cable. First, FIG. 5 shows that the propagation delay for the embodiment illustrated in FIG. 3 is less than the propagation delay in a conventional fiber optical cable. Thus, referring to the hypothetical distributed computing system introduced in the background, a waveguide conforming to the invention providing a communication path between two computers, A and B, speeds up the communication between A and B.

Second, FIG. 5 shows that the propagation delay in a waveguide 10 according to the present invention is a function of the gain region 14 thickness. In an embodiment of the invention having a plurality of evanescent regions 12 and gain regions 14 arranged with some space therebetween, the propagation delay is also a function of the width of the space. Both the gain region thickness and the width of the space affect propagation delay because both affect the time that the signal spends in the evanescent region. Generally speaking, if the signal is in the evanescent region, it is experiencing reduced propagation delays. Conversely, if the signal is not in the evanescent region, such as when it is in the gain region or being propagated through a fiber core, it is not experiencing reduced propagation delays. In the example of FIG. 2B, the plurality of evanescent regions and gain regions are arranged back-to-back with no space therebetween; thus, there is no affect on propagation delay by the space, such as in FIG. 2A.

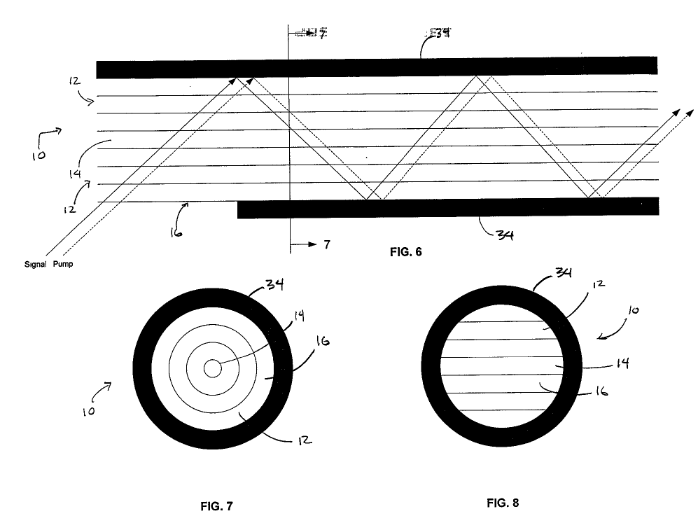

FIG. 6 illustrates an alternative waveguide 10 structure according to the present invention that includes a mirror or other reflecting structure 14 defining an outside cylindrical surface and includes one or more thin film layers 16 within the reflecting surface. FIG. 7 is a cross section of the waveguide illustrated in FIG. 6 taken along line 7-7. In this embodiment, the alternating thin film layers 16 define coaxial cylinders with varying outside diameters so that the thin film layer cylinders may fit within one another. The gain region 14 also defines a cylinder within the outside surface.

Alternatively, the thin film layers 16 may define planar layers stacked on top of one another, with the gain region 14 sandwiched therebetween. FIG. 8 is a cross section of the waveguide illustrated in FIG. 7 with the thin film layers oriented in parallel planes. The gain region is sandwiched in the thin film region. Alternatively, the thin film layers are also configured to provide the gain region.

Referring again to FIGS. 6 and 7, the communication signal enters the waveguide from the bottom left at an angle and propagates through the thin film region 16 and the gain region 14. Entering at an angle, as the communication signal propagates through the waveguide 1—it reflects off the mirror structures 34. Thus, the signal repeatedly bounces through the thin film regions and the gain region along the length of the waveguide 10 until it reaches the end of the structure. The amplification signal also enters the waveguide from the bottom left at an angle and propagates through the thin film region and the gain region.

In the thin film evanescent region 12, the signal velocity is increased. As earlier described, as the signal is accelerated it also experiences attenuation. Thus, in the gain region 14, the signal is amplified to remove the attenuation.

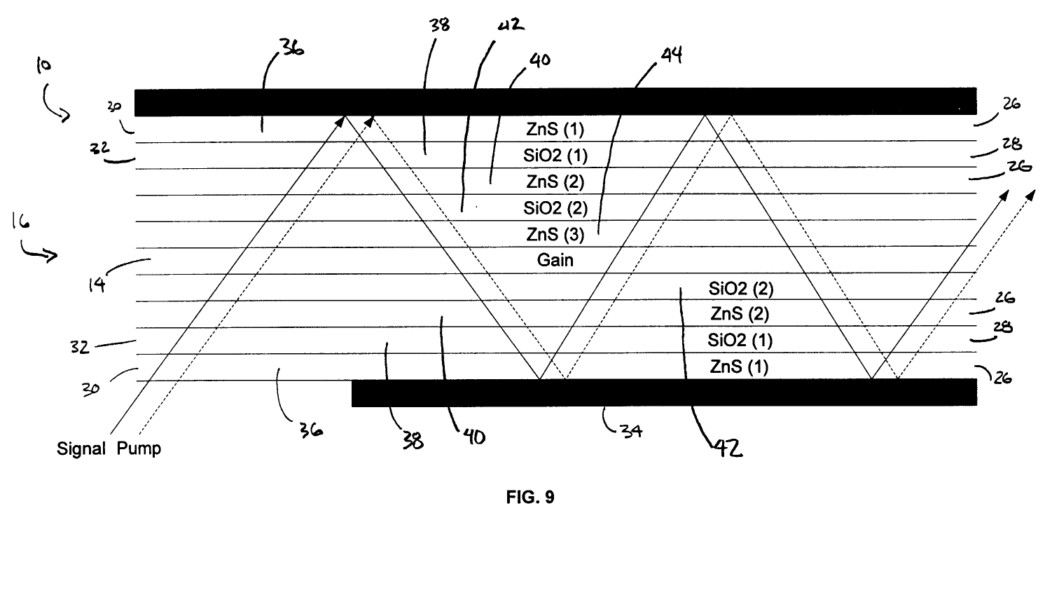

FIG. 9 is a diagram illustrating one specific embodiment of the waveguide illustrated in FIGS. 6 and 7. The waveguide includes a nine-layer thin film region 16 with alternating high index layers 26 and low index layers 28, and a gain region 14 sandwiched within the thin film region. The thin film region includes alternating high index of refraction ZnS 30 layers and low index of refraction SiO₂ 32 layers. In particular, the thin film region includes five ZnS layers implemented as three cylinders and four SiO₂ layers implemented as two cylinders. As with other embodiments discussed herein, numerous alternative thin film arrangements and materials are possible that conform to the present invention. Moreover, the gain region can be located anywhere in the thin film region.

Referring to FIG. 9, a first low index of refraction ZnS(1) region is defined by a first outermost cylindrical area 36. Because the light wave enters the waveguide 10 at an angle, in its path through the waveguide it passes through the first ZnS(1) region twice during each transition between reflections. Hence, a single thin film cylindrical region defines two layers.

A first SiO₂(1) region is defined by a second cylindrical region 38 within the first outermost cylindrical region 36. The first SiO₂(1) region defines two low index of refraction layers. A second ZnS(2) high index region is defined by a third cylindrical region 40 within the second cylindrical region 38 (SiO₂(1). The second ZnS(2) region defines two high index of refraction layers. A second SiO₂(2) low index region is defined by a fourth cylindrical region 42 within the third cylindrical region 40. The second SiO₂ region defines two low index layers. A third high index ZnS(3) region defines a central fifth high index layer 44. The gain region 14 is located adjacent the third high index ZnS(3) region and within the second low index SiO₂(2) region.

In one example of signal transmission in the FIG. 9 embodiment, the incoming communication signal is an S-polarization signal, and the communication signal photons and the pump photons enter the waveguide at a 45 degree angle. Other polarization and incidence angles can be used as well. The communication signal light waves propagate through the thin film regions 16 and the gain regions 14 repeatedly as they are reflected back into the structure by the reflecting surface on the outside of the waveguide. For the embodiment of FIG. 9, the propagation delay is 37% of a conventional fiber optic cable according to Equation 8 in the thin film region. Once again, propagation delay through the waveguide is less than the propagation delay through a conventional fiber optic cable.

Various alternative embodiments of the invention that do not use a thin film region for the evanescent region are also possible. In one alternative, an optical waveguide conforming to the present invention defines one or more evanescent regions including a Fiber-Bragg Grating (FBG), and defines one or more gain regions following the evanescent region. In another alternative, an optical waveguide conforming to the present invention defines one or more evanescent regions including a frustrated total internal reflection (FTIR) structure, and defines one or more gain regions following the evanescent region. A microwave or optical waveguide conforming to the present invention defines one or more evanescent regions including an undersized waveguide structure, and defines one or more gain regions following the evanescent region. An electrical waveguide conforming to the present invention defines one or more evanescent regions followed by one or more gain regions.

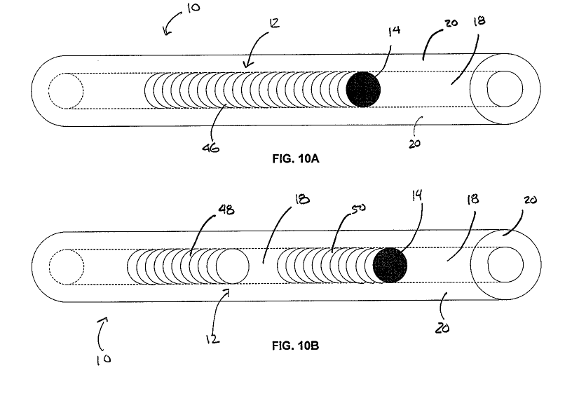

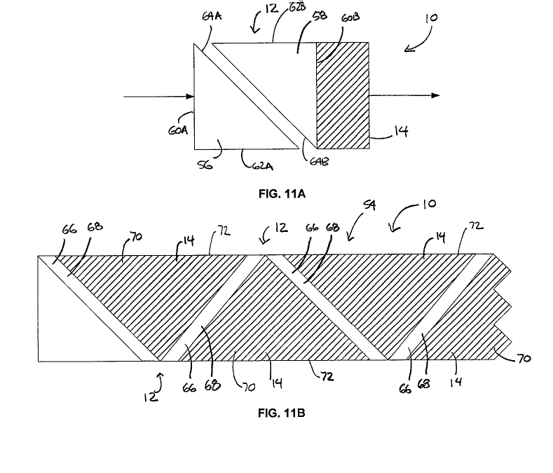

FIG. 10A is a diagram of a waveguide 10 according to one embodiment of the invention having an evanescent region 12 employing a FBG 46 followed by a gain region 14. The waveguide includes a core 18 with a high refractive index and a cladding 20 with a low refractive index. A waveguide 10 conforming to the present invention may include one FBG region followed by a gain region or may include a plurality of FBG regions and gain regions arranged along the core. In an embodiment with a plurality of FBG regions and gain regions, the regions may be arranged back-to-back or with some space therebetween.

FIG. 10B is a schematic diagram of a waveguide 10 according to one embodiment of the invention having an evanescent region 12 employing a first FBG 48 and second FBG 50 with a space therebetween, with the first and second FBG followed by a gain region 14. As with the embodiment shown in FIG. 10A and other embodiments conforming to the present invention, a waveguide may include one first and second FBG and gain region, or may include a plurality of first and second FBG regions and gain regions arranged back-to-back or with space therebetween. In one example, the core 18 is present in the space between the first and second FBG.

The FBG (46, 48, 50) is a periodic variation of the refractive index of the optical fiber core 18 along the length of the fiber. The FBG acts like a narrowband mirror as it reflects a narrow range of wavelengths and transmits all the other wavelengths. The center of the reflected wavelength band, λ_{B}, is given by λ_{B}=2nΛ, where Λ is the spatial period of the index variation and n is the effective index. The index variations are formed by exposing the fiber to an intense ultraviolet (UV) source which changes the index of sections of the fiber core which are irradiated to the UV light.

FBGs are commonly used to remove a spectrum of light and define optical channels, such as in Wavelength Division Multiplexing (WDM) and Dense Wavelength Division Multiplexing (DWDM) optical communication systems. One example of an FBG is the JDS Uniphase™, Part #DWS Series. Chirped FBGs, where the grating period varies linearly along the fiber are commonly used for dispersion compensation in fiber communication systems. One example of a chirped FBG is the Teraxion™, Part #TH-DCX.

A fiber grating 46 can be imposed on a conventional optical fiber by well-known fabrication techniques. For example, placing an optical “mask” over a photo-sensitive fiber core and then illuminating the mask with an ultraviolet light imposes a fiber grating on an optical fiber. Pursuant to implementation of an embodiment of the present invention, the fiber grating is configured to define a photonic bandgap.

Similar to the embodiment of the present invention utilizing thin film, a waveguide 10 employing a fiber grating (46, 48, 50) for the evanescent region 12 comprises sections having different indices of refraction spaced along the fiber or waveguide followed by the gain region 14. In one example, the FBG displays a sinusoidal varying index of refraction. Thus, the fiber grating embodiments operate according to the same general principles that apply to the thin film embodiments described above. When the ultraviolet light, such as from an excimer laser, is applied to the fiber core with the mask, the index of refraction is changed in the portion of the fiber that is exposed to the illumination. The index of refraction for the exposed areas is permanently altered. Accordingly, the waveguide includes sections where the index of refraction is altered and sections where the refractive index is unchanged, in one example.

FIG. 11A is a schematic diagram illustrating a waveguide 10 conforming to the invention, including an evanescent region 12 employing a FTIR construct 52 and a gain region 14. FIG. 11B is a schematic diagram illustrating a waveguide 10 conforming to the invention, including an evanescent region 12 employing an alternative FTIR construct 54 and a plurality of gain regions 14. Evanescent wave propagation in these embodiments is provided by the FTIR structure 52, 54. FTIR occurs when the angle of incidence of the light is greater than the critical angle and when light propagates to a boundary between a higher index of refraction and a lower index of refraction material.

As is known in the art, total internal reflection occurs when light passes from a higher to lower index of refraction at an angle of incidence with a sine equal to or exceeding N′/N (N′=lower index, N=higher index). In total internal reflection, the light is totally reflected back into the denser medium. In the case of conventional fiber optic cabling and in the case of the embodiment of the invention illustrated in FIG. 2 and others, the outer cladding 20 has a lower index of refraction than the core 18, and thus light being transmitted in the core stays within the core. Total internal reflection is frustrated, i.e., FTIR, when there is anything near the other side of the boundary surface. In FTIR, a portion of the incident light is transmitted through the lower index of refraction material, and a portion the incident light is reflected. Hence, the overall light pulse being transmitted in a FTIR structure is attenuated. In embodiments of the invention employing a FTIR construct, the signal is also accelerated in the FTIR region.

Referring to FIG. 11A, the FTIR evanescent region includes two prism-like areas 56, 58, in one example. In one example, the prism-like area is formed from targeted doping of the core. Hence, the prism-like area is not a true prism, but a prism shaped region. Nonetheless, prisms could be used in an embodiment conforming to the invention. Each prism defines a first sidewall region and a second sidewall region 62A, 62B having the same length arranged at a right angle, and a third longer sidewall region 64A, 64B between the first and second sidewall regions such that a side view of the prism regions 56, 58 generally define a right triangle. The prism regions are arranged so that the third sidewall regions 64A, 64B of each prism are adjacent each other with a small space between them. The space between the prisms causes frustrated total internal reflection.

As shown in FIG. 11A, the signal enters the first prism region 56 through the first sidewall region 60A (or second sidewall depending on orientation) and propagates therethrough and emerges along the third sidewall region 64A. The signal then propagates across the space between the prism regions 56, 58 and enters the third sidewall region 64B of the second prism region 58. A portion of the signal, however, does not pass into the second prism region due to FTIR. The portion that does pass into the second prism propagates therethrough, and emerges along the first 60B (or second) sidewall region of the second prism region 58. The signal having passed through the evanescent region 12 defined by the cooperating prism regions, is sped up and attenuated. The signal is amplified, such as back to its preattenuation signal strength, in the gain region 14 following the FTIR construct 52. The gain region includes a silicon nanocrystal, polariton, or other such electrically powered optical amplifier, in one example. As with other embodiments, a plurality of FTIR type waveguides conforming to the present invention may be serially arranged along the path a signal takes from a source to a destination.

Referring to FIG. 11B, the FTIR evanescent region 54 includes a plurality of boundaries 66 defined by low index regions 68 between a plurality of high index regions 70. The boundaries 66 are arranged at an angle to the propagation path of an electromagnetic wave through the waveguide 10. In the FIG. 11B embodiment, the gain region 14 is integrated in the high index region 70. The plurality of boundaries defined, in one example, by a plurality of high index of refraction prism regions 72 arranged with the adjacent faces of the prism regions spaced apart to define low index regions 68 between the prisms, and arranged so that the adjacent faces are at an angle to the propagation path of the electromagnetic wave(s) through the waveguide. The plurality of low index regions, and high index regions and the angularly oriented boundaries therebetween, are defined by targeted doping of a fiber core. The high index regions also define a gain region formed by appropriate core doping.

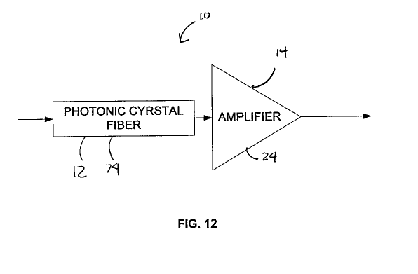

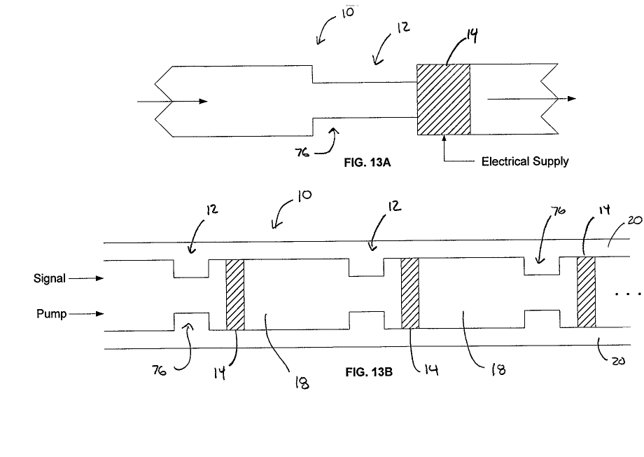

FIG. 12 is a block diagram illustrating a waveguide comprising an evanescent region 12 including a Photonic Crystal Fiber (PCF) 24 and a gain region 14. PCFs include a core and cladding similar to conventional fiber optic cabling. PCFs also include an array of air holes distributed along the length of the core, which create a photonic bandgap. The PCF structure, as with other evanescent structures described herein, is configured to continue propagation of the attenuated signal and to increase the velocity of the attenuated signal. In accordance with the present invention, a PCF structure is coupled with a gain region, such as an optical amplifier 14, to provide a waveguide to reduce propagation delays typically found in conventional waveguides.

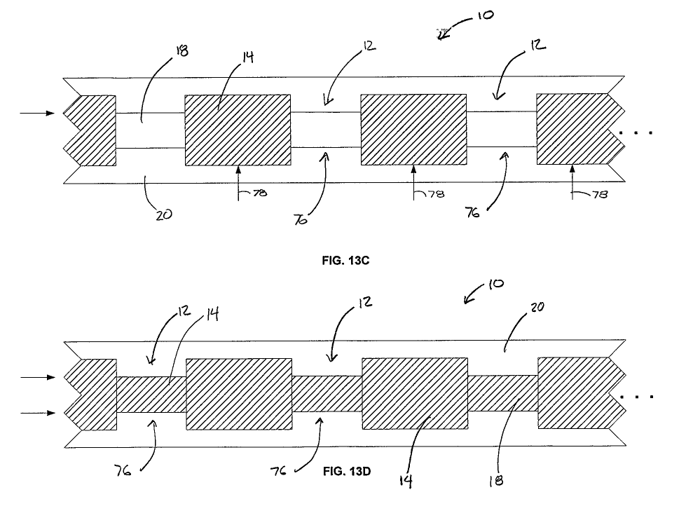

FIG. 13A illustrates a microwave waveguide 10 in accordance with the invention. The microwave waveguide includes an evanescent region 12 followed by a gain region 14 integrated in a rectangular waveguide structure. In one example, the evanescent region of the microwave waveguide includes an undersized waveguide 76 configuration. An embodiment conforming to the present invention may include a single undersized region 76 and a gain region 14, or may include a plurality of undersized regions and gain regions arranged back-to-back or with space therebetween. The undersized waveguide is a rectangular waveguide structure, with a frequency cutoff higher than the signal frequency. The cutoff frequency is a function of the dimensions of the waveguide and the dielectric properties of the waveguide. In one embodiment, the cutoff frequency is 7.5 GHz with dimensions of 2 cm by 1 cm.

As with other evanescent region structures discussed herein, the undersized waveguide can cause signal attenuation. Following the undersized waveguide, the microwave waveguide includes a gain region 14, which restores the attenuated signal. The gain region for the microwave waveguide may be implemented with any number of microwave amplifiers, such as the QuinStar™ QGW, QLW, QPW, QLN, or QPN series type amplifiers. Some microwave amplifiers include an RF coaxial female input and an RF coaxial female output for receiving and transmitting the signal, respectively. Accordingly, in one embodiment, the undersigned waveguide portion of the microwave waveguide according to the invention defines a coaxial male output for coupling with the RF coaxial input.

FIG. 13B illustrates an optical waveguide 10 according to the present invention that includes a plurality of undersized regions 76, with each undersized region followed by a gain region 14. The waveguide further includes a cladding 20 surrounding a core 18. The undersized waveguide cutoff wavelength is designed such that the signal wavelength (e.g., 1550 nm) is longer than the cutoff wavelength, but the pump wavelength (e.g., 980 nm), such as with an EDFA amplifier, is shorter than the waveguide cutoff wavelength. Thus, the pump photons travel without significant attenuation through the evanescent region. In one example, the cutoff wavelength of the evanescent region is 1200 nm. With a 1200 nm cutoff wavelength, the undersized waveguide has a diameter of 6 um.

FIG. 13C illustrates an optical waveguide according to the present invention that includes a plurality of undersized waveguide regions 76, with each undersized region followed by a gain region 14. The embodiment of FIG. 13C includes a cladding 20 surrounding a core 18. The FIG. 13C embodiment differs from the FIG. 13B embodiment primarily in the gain region 14. First, the FIG. 13B embodiment includes a gain region that uses a pump signal, such as an EDFA amplifier. In contrast, the FIG. 13C embodiment includes a gain region that uses an electrical power source 78 to amplify the signal, such as with semiconductor optical amplifiers. Second, the gain region in the FIG. 13B embodiment employs a gain region that does not occupy the entire space between undersized waveguides, whereas the gain region in the FIG. 13C embodiment employs a gain region that does not occupy the entire space between undersized waveguides.

FIG. 13D illustrates an optical waveguide 10 according to the present invention that includes a plurality of undersized waveguide regions 76 and gain regions 14 integrated along the entire core 18, which is surrounded by a cladding 20. It will be recognized by persons of ordinary skill in the art, that various elements shown in the embodiments of FIGS. 13B-13D may be combined, rearranged, added, removed, or otherwise substituted to define embodiments conforming to the invention and without departing from the spirit and scope of the present invention.

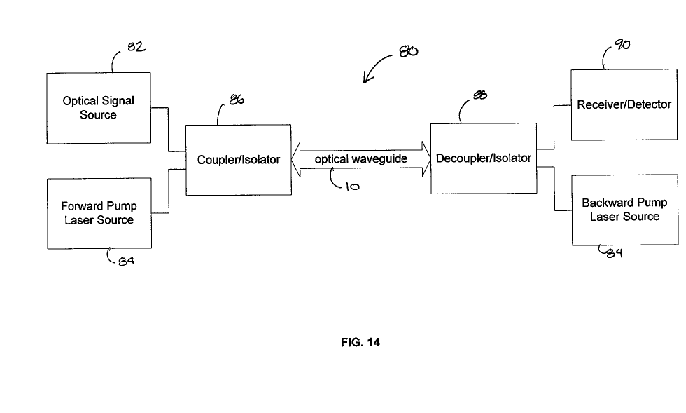

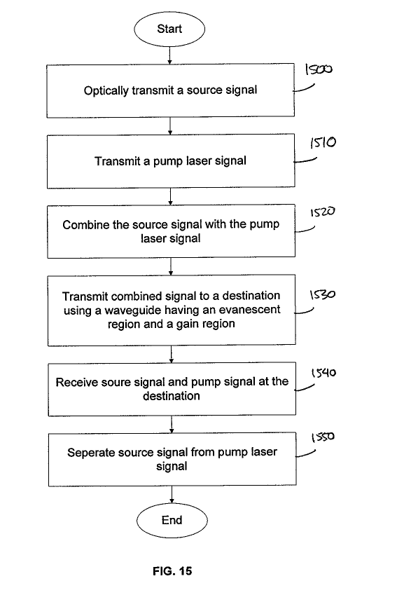

FIG. 14 is a block diagram of a signal transmission system 80 according to one embodiment of the invention for use in employing a waveguide 10 according to the present invention. FIG. 15 is a flow chart illustrating a method for propagating a signal in a waveguide, according to the present invention. Generally speaking, a waveguide conforming to the present invention may be employed to propagate a conventional communication signal in any conventional communication system. One example of a communication signal and a conventional communication infrastructure in which aspects of the invention may be employed is computer data being transmitted between a server machine, i.e., a source, and a client machine, i.e., a destination, in a client server environment. Upon request from the client device, the server transmits the computer data to the client device over a network, such as a wide area network, the Internet, and the like. Along the path between the server and the client machine, the computer data is transmitted along the waveguide and the signal transmission system. The computer data originates at the server device in the form of an electric signal. In one example, the signal is converted into an optical signal for transmission across the optical waveguide embodiment. For the client device to use the signal, it is converted back into an electrical signal.

As used herein, the term “optical” or “optical signal” is meant to include any photon-based transmission. Other signal types transmittable with embodiments of the invention include radio wave-based signals and electron-based signals.

Referring particularly to FIGS. 14 and 15, on the input side of the signal transmission system 80, the communication signal is received at the optical signal source 82. The communication signal may be received at the optical signal source in the form of an optical signal or an electronic signal. If necessary, at the optical signal source, the communication signal is converted into an optical signal and is transmitted onto the waveguide 10 (operation 1500). In addition, an amplification signal is also transmitted onto the waveguide from a forward pump laser source 84 (operation 1510). The signal transmission system illustrated in FIG. 14 is optimized for use with embodiments of the waveguide that employ a pump laser as part of the amplification of the signal. In alternative configurations of the signal transmission system, the pump laser amplification signal is added into the optical waveguide along any point of the length of the waveguide using a coupler and a pump laser source.

In one example, the communication signal and the amplification signal are both optical signals having different wavelengths that are generated using a communication signal laser and a pump laser, respectively. The communication signal laser source 82 is a laser diode, which is modulated either directly, or externally with the received communication signal to propagate the communication signal along the waveguide 10. The signal laser source also includes an isolator which prevents light from being reflected back in the signal laser source.

The communication laser signal and the pump laser amplification signal are both propagated onto the waveguide using an optical coupler 86 (operation 1520). After combination, the communication signal and the amplification signal are fed from the optical coupler onto the waveguide 10 (operation 1530). The coupler 86A and decoupler 88 include an isolator, in one example, that substantially prevents reflected light, signal or pump, from entering the signal source 82 or pump laser source 84. The signals are then transmitted from the input side to the output side within the waveguide 10. In one example, the waveguide illustrated in FIG. 3 is employed in the signal transmission system 80. Accordingly, the waveguide includes a thin film region and an optical amplifier.

The communication signal propagates through the evanescent region, e.g., the thin film region, with less propagation delays than would be experienced in a conventional fiber optic cable. In some instances, the communication signal experiences attenuation as it passes through the thin film region. In contrast, the amplification signal passes substantially unattenuated through the thin film regions of the waveguide 10. In the amplification region, the amplification signal acts to amplify the communication signal and effectively remove the attenuation that the communication signal experiences in the thin film region.

At the output side, the communication signal and amplification signal are received (operation 1540) and the decoupler 88 separates the communication signal from the amplification signal (operation 1550). The communication signal is then transmitted to an optical detector 90 to convert the optical communication signal into an electrical signal. The electric signal is then transmitted to the intended recipient of the signal using conventional networking systems, such as networking routers and the like. The electric signal may also be transmitted to one or more additional signal transmission systems where the electric signal from the first signal transmission system is converted into an optical signal and transmitted to the next recipient. Such multiple signal transmission systems may be employed in a conventional internet protocol type network that oftentimes requires a communication signal to go through multiple hops between a source and a destination.

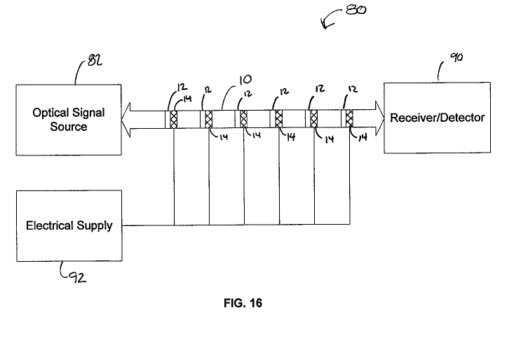

An alternative signal transmission system 80 is illustrated in FIG. 16. The configuration illustrated in FIG. 16 employs a waveguide 10 conforming to the present invention with a silicon nanocrystal amplifier, semiconductor optical amplifier, or the like, that does not require pump photons, but instead provides amplification using an electrical supply 92. In such a configuration, and other configurations that do not require a pump, the signal transmission system 80 includes the electrical supply 92. On the input side, an optical signal source 82 transmits a signal along the waveguide. The electrical supply provides power to each of the gain regions 14 (e.g., semiconductor optical amplifiers) in the waveguide. Accordingly, the signal propagates through the waveguide and experiences velocity enhancements in the evanescent regions 12 and amplification in the gain regions 14. On the output side, the signal is received by a receiver/detector 90.

Besides data networks, another example of a communication signal and a conventional communication infrastructure in which aspects of the invention may be employed is a voice signal transmitted between two telephones in the existing telephone communication infrastructure. Another example of a communication signal and a conventional communication infrastructure in which aspect of the invention may be employed is a voice or data signal transmitted between two devices in a wireless network, such as a cellular network or other wireless type network.

Another example of a communication signal and a conventional communication infrastructure in which aspects of the invention may be employed is a microwave signal transmitted in a microwave type network. Another example of a communication signal and a conventional communication infrastructure in which aspects of the invention may be employed is an analog or digital signal transmitted along a trace on a backplane, a wire, or a PC board, between two components in a conventional computing system, such as a memory access between a central processing unit and a memory device in a personal computer. Finally, another example of an environment in which embodiments of the invention may be employed is in an integrated circuit (IC). As is well known, IC's include various doped silicon regions. An embodiment of the invention is employed, in one example, in the communication path between functional units in the IC. Along the communication path, doping is employed to create waveguides with evanescent regions and gain regions conforming to the present invention.

Every possible type of communication signal and communication network in which aspects of the invention may be employed is not specifically outlined here. For convenience, the present invention is described in relation to these example environments. B owever, it is not intended that the invention be limited to application in these example environments. In fact, from the above description, it will be apparent to a person skilled in the relevant art how to implement the invention in alternative environments.

The following documents 1-11 are referenced in the provisional patent application from which the present application claims priority. Each of these documents is hereby incorporated by reference in their entirety.

[1] Partha P. Mitra, Jason B. Stark, Bell Laboratories, Lucent Technologies, Murray Hill, N.J. 07974 Nonlinear limits to the information capacity of optical fiber communications Submitted to Nature, Nov. 7, 2000, and published in Nature 411, 1027-1030 (2001).

[2] Liu, C., Dutton, Z., Behroozi, C. H. & Hau, L. V. Nature 409, 490-493 (2001)

[3] D. F. Phillips, A. Fleischhauer, A. Mair, R. L. Walsworth, and M. D. Lukin Physical Review Letters Volume 86, Issue 5, 783-786 (2001)

[4] Wang L. J., Kuzmich A., Dogariu A. Nature 406, 270-279 (2000)

[5] Steinberg, A. M., Kwiat, P. G. & Chiao, R. Y. Phys. Rev. Lett. 71, 708-711 (1993)

[6] Heitmann, W., Nimtz, G., Phys. Lett A 196, 154 (1993)

[7] J. R. Oppenheimer, Phys. Rev. 31, 66 (1928)

[8] French, A. P., Tayler, E. F. Quantum Physics (1978)

[9] Landauer, R., Martin, T., Phys. Rev. A 45, 2611-2617 (1992)

[10] Steinberg, A. M., Phys. Rev. Lett. 74 2405-2409 (1995)

[11] Bass, M. et al. editors, Handbook of Optics 2^{nd} Edition Volume IV (2001)

While various embodiments of the present invention have been described above, it should be understood that they have been presented by way of example only, and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined only in accordance with the following claims and their equivalents.

What is claimed is:

1. A waveguide defining a path for propagating an electromagnetic signal having a signal frequency comprising:
at least one evanescent region; and
at least one gain region operably coupled with the at least one evanescent region.

2. The waveguide of claim 1 wherein the at least one evanescent region defines a photonic bandgap at the signal frequency.

3. The waveguide of claim 1 wherein the at least one evanescent region includes at least one first region having a first index of refraction and at least one second region having a second index of refraction that is different than the first index of refraction.

4. The waveguide of claim 3 wherein the at least one first region includes a first thin film layer and the at least one second region includes a second thin film layer.

5. The waveguide of claim 4 wherein the first thin film layer is selected from the group consisting of Aluminum, Aluminum Fluoride, Aluminum Copper, Aluminum Oxide, Aluminum Silicon, Aluminum Copper Silicon, Barium and Barium Fluoride, Cadmium Telluride, Carbon, Cermet, Chromium, Chrome Oxide, Cobalt, Copper, Copper Oxide, Germanium, Germanium Oxide, Gold, Gold/Germanium Alloy, Indium, Indium Tin, Indium Tin Oxide, Indium Oxide, Iron and Iron Oxide, Lead, Lead Selenide, Lead Sulphide, Magnesium, Magnesium Fluoride, Magnesium Oxide, Manganese, Molybdenum, Molybdenum Oxide, Nickel, Nickel Chrome, Nickel Iron, Niobium, Niobium Oxide, Palladium, Platinum, Rhodium, Ruthenium, Silicon, Silicon Dioxide, Silicon Monoxide, Silicon Carbide, Silver, Tantalum, Tantalum Carbide, Tantalum Oxide, Tin, Tin Oxide, Titanium, Titanium Carbide, Titanium Nitride, Titanium Oxides, Tungsten, Tungsten Carbide, Tungsten Oxide, Tungsten Titanium, Yttrium, Yttrium Oxide, Zinc Selenide, Zinc Sulfide, Zinc Telluride, Zirconium, and Zinconium Monoxide and Dioxide.

6. The waveguide of claim 4 wherein the second thin film layer is selected from the group consisting of Aluminum, Aluminum Fluoride, Aluminum Copper, Aluminum Oxide, Aluminum Silicon, Aluminum Copper Silicon, Barium and Barium Fluoride, Cadmium Telluride, Carbon, Cermet, Chromium, Chrome Oxide, Cobalt, Copper, Copper Oxide, Germanium, Germanium Oxide, Gold, Gold/Germanium Alloy, Indium, Indium Tin, Indium Tin Oxide, Indium Oxide, Iron and Iron Oxide, Lead, Lead Selenide, Lead Sulphide, Magnesium, Magnesium Fluoride, Magnesium Oxide, Manganese, Molybdenum, Molybdenum Oxide, Nickel, Nickel Chrome, Nickel Iron, Niobium, Niobium Oxide, Palladium, Platinum, Rhodium, Ruthenium, Silicon, Silicon Dioxide, Silicon Monoxide, Silicon Carbide, Silver, Tantalum, Tantalum Carbide, Tantalum Oxide, Tin, Tin Oxide, Titanium, Titanium Carbide, Titanium Nitride, Titanium Oxides, Tungsten, Tungsten Carbide, Tungsten Oxide, Tungsten Titanium, Yttrium, Yttrium Oxide, Zinc Selenide, Zinc Sulfide, Zinc Telluride, Zirconium, and Zinconium Monoxide and Dioxide.

7. The waveguide of claim 4 wherein the first thin film layer and the second thin film layer are oriented substantially transverse to the path.

8. The waveguide of claim 4 wherein the first thin film layer and the second thin film layer are oriented substantially parallel to the path.

9. The waveguide of claim 3 wherein the first index of refraction is about 1.5

10. The waveguide of claim 3 wherein the second index of refraction is about 2.3.

11. The waveguide of claim 3 wherein the at least one first region is adjacent the at least one second region.

12. The waveguide of claim 3 wherein the at least one first region together with the at least one second region are repeated along the path.

13. The waveguide of claim 1 wherein the evanescent region includes at least one frustrated total internal reflection construct.

14. The waveguide of claim 13 wherein the at least one frustrated total internal reflection construct includes a first prism region and a second prism region.

15. The waveguide of claim 14 wherein the first prism region and the second prism region define a boundary region therebetween.

16. The waveguide of claim 13 wherein the at least one frustrated total internal reflection construct defines at least one first high index region and at least one second high index region with a low index boundary region therebetween, the boundary region being angularly oriented with respect to the path.

17. The waveguide of claim 1 wherein the evanescent region includes at least one photonic crystal fiber.

18. The waveguide of claim 1 wherein the evanescent region includes at least one undersized waveguide.

19. The waveguide of claim 18 wherein the at least one undersized waveguide has frequency cutoff higher than the signal frequency.

20. The waveguide of claim 1 wherein the evanescent region includes at least one means for defining the evanescent region.

21. The waveguide of claim 1 wherein the at least one gain region includes means for amplifying the signal.

22. The waveguide of claim 1 wherein the at least one gain region includes an optical amplifier operably coupled with the evanescent region.

23. The waveguide of claim 1 wherein the at least one gain region is integrated in the at least one evanescent region.

24. The waveguide of claim 1 further comprising:
a core defining a first index of refraction; and
a cladding surrounding the core, the cladding defining a second index of refraction less than the first index of refraction such that the electromagnetic signal is propagated within the core.

25. The waveguide of claim 24 wherein the core further defines at least one region having a periodic variation of the index of refraction.

26. The waveguide of claim 25 wherein the core further defines at least one fiber grating having a periodic variation of the index of refraction.

27. The waveguide of claim 26 wherein:
the at least one fiber grating defines a first fiber grating section and a second fiber grating section;
the first fiber grating section and the second fiber grating section being separated by a portion of the core; and
the core further defining an amplification region adjacent the second fiber grating section.

28. The waveguide of claim 1 wherein the evanescent region is configured to increase the velocity of the electromagnetic signal as the electromagnetic signal propagates therethrough.

29. The waveguide of claim 28 wherein the gain region is configured to amplify the electromagnetic signal following increase in velocity of the electromagnetic signal.

30. An optical waveguide for propagating a signal having a signal wavelength and for propagating a pump signal having a pump wavelength comprising:
at least one first region having a first index of refraction;
at least one second region coupled with the first region, the second region having a second index of refraction;
the first index of refraction being different than the first index of refraction such that the first index of refraction and the second index of refraction define a photonic bandgap at the signal wavelength;
the first index of refraction and the second index of refraction configured to transmit the pump signal without substantial attenuation; and
at least one amplifier operably coupled with the at least one first region and the at least one second region.

31. The waveguide of claim 30 wherein the at least one first region includes at least one first thin film.

32. The waveguide of claim 30 wherein the at least one second region includes at least one second thin film.

33. The waveguide of claim 30 wherein the at least one first region and the at least one second region includes at least one fiber grating.

34. The waveguide of claim 30 wherein the optical amplifier includes an optical fiber amplifier.

35. The waveguide of claim 30 wherein the optical amplifier includes means for amplifying the signal using the pump signal.

36. An optical waveguide for propagating a signal having a signal frequency comprising:
at least one first region having a first index of refraction;
at least one second region coupled with the first region, the second region having a second index of refraction;
the first index of refraction being different than the first index of refraction such that the first index of refraction and the second index of refraction define a photonic bandgap at the signal frequency;
at least one amplifier operably coupled with the at least one first region and the at least one second region.

37. The waveguide of claim 36 wherein the at least one first region includes at least one first thin film.

38. The waveguide of claim 36 wherein the at least one second region includes at least one second thin film.

39. The waveguide of claim 36 wherein the at least one first region and the at least one second region includes at least one fiber grating.

40. The optical waveguide of claim 36 wherein the at least one amplifier is connected with an electric power supply, and wherein the at least one amplifier includes means for amplifying the light pulses using an electric power source.

41. An optical waveguide for propagating a signal having a signal wavelength and for propagating a pump wavelength signal having a pump wavelength comprising:
an undersized waveguide with a wavelength cutoff higher than the signal wavelength, and with a cutoff wavelength lower than the pump wavelength; and
an amplification region operably coupled with the undersized waveguide, the amplification region configured to amplify the signal.

42. The optical waveguide of claim 41 wherein the cutoff wavelength is 1200 nanometers.

43. A waveguide for propagating a signal along a path comprising:
at least one means for defining an evanescent region; and
at least one means for amplifying the signal operably coupled with the means for defining an evanescent region.

44. The waveguide of claim 43 wherein the at least one means for defining an evanescent region is adjacent the atg least one means for amplifying the signal.

45. A signal guiding apparatus comprising:
a signal source;
a pump laser source;
a waveguide defining an input and an output, the waveguide further including at least one evanescent region operably coupled with at least one gain region;
the evanescent region configured to increase the velocity of the signal;
the amplification region configured to amplify the signal;
a coupler operably connected with the signal laser source and with the pump laser source, the coupler further operably coupled with the input of the waveguide; and
a decoupler operably connected with the output of the waveguide.

46. The signal guiding apparatus of claim 45 wherein the coupler includes an isolator.

47. A method of propagating a signal comprising:
step for increasing the velocity of the signal; and
step for amplifying the signal.

48. A method of propagating a signal having a signal frequency comprising:
providing at least one evanescent region configured to attenuate the signal frequency of the signal;
providing at least one amplification region configured to amplify the attenuated signal;
propagating the signal through the evanescent region;
propagating the attenuated signal through the amplification region.

49. The method of claim 48 further comprising:
propagating a pump signal through the evanescent region; and
propagating a pump signal through the amplification region.

50. The method of claim 48 further comprising:
supplying electrical power to the amplification region.

51. The method of claim 48 wherein the evanescent region includes a thin film region.

52. The method of claim 48 wherein the at least one evanescent region includes an undersized waveguide.

53. The method of claim 48 wherein the at least one evanescent region includes a photonic crystal fiber.

54. The method of claim 48 wherein the at least one evanescent region includes a frustrated total internal reflection construct.

55. The method of claim 48 wherein the at least one evanescent region includes means for providing an evanescent region.

56. The method of claim 49 wherein the at least one amplification region includes a fiber doped amplifier.

57. The method of claim 50 wherein the at least one amplification region includes a silicon nanocrystal amplifier.

58. The method of claim 50 wherein the at least one amplification region includes a polariton amplifier.

59. The method of claim 48 wherein the at least one amplification region includes means for amplifying the signal.

60. The method of claim 48 whereby the operation of transmitting the signal through the first evanescent region increases the velocity of the signal.
